(19) United States
(12) Patent Application Publication
(10) Pub. No.: US 2026/0048397 A1
(43) Pub. Date: Feb. 19, 2026

(54) MINERAL SEPARATION SYSTEM

(71) Applicant: Mason-Grey Corporation, Atlanta, GA (US)

(72) Inventor: Joseph Reini, Kennesaw, GA (US)

(73) Assignee: Mason-Grey Corporation, Atlanta, GA (US)

(21) Appl. No.: 18/804,709

(22) Filed: Aug. 14, 2024

(51) Int. Cl. B03B 9/00; B03B 5/34; B03B 5/52

(52) U.S. Cl. CPC B03B 9/00; B03B 5/34; B03B 5/52

(57) ABSTRACT

A system configured to separate minerals is disclosed. The system may include one or more crushers configured to crush ore. The system may further include a hydrocyclone configured to receive and process a feed to divide the feed into a first feed portion and a second feed portion. The feed may be a mixture of crushed ore and water. The system may further include a plurality of spiral circuits configured to process the second feed portion to divide the second feed portion into concentrate and tailings. The concentrate may include copper and the tailings may include basalt. The system may further include one or more processing components configured to process the tailings to form a supplementary cementitious material.

### TECHNICAL FIELD

The present disclosure relates to a mineral separation system configured to produce a supplementary cementitious material and, at the same time, create a valuable resource copper in usable form.

### BACKGROUND

Copper is generally obtained/extracted from its ores. To extract the copper from the ores, the ores are generally crushed, grounded, and then subjected to physical and chemical processes to separate the copper minerals from other materials (e.g., waste rock). Some of the processes/methods includes crushing, grinding, flotation, smelting, and refining processes. The method/process is selected based on ore source, local environmental regulations, etc.

Typically, copper is obtained from Chalcopyrite, copper sulfide and basic carbonates, cuprite or ruby copper, copper glance, and copper pyrite. In addition, copper is also found in metallic form in basalt. Conventional copper extraction processes generate byproducts, which typically go to waste.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a schematic diagram of an example overall process to extract minerals in accordance with the present disclosure.

FIG. 2 depicts an example system to separate concentrate and tailings from a feed in accordance with the present disclosure.

FIG. 3 depicts an example flow diagram of a method to extract minerals in accordance with the present disclosure.

### DETAILED DESCRIPTION

### Overview

The present disclosure is directed towards a system and process/method to create a supplementary cementitious material (or cementitious additive), and at the same time create a valuable resource copper in usable form.

To create the supplementary cementitious material and copper, a series of steps may be performed on mined ore (e.g., basalt). The steps may include crushing, screening, mixing, separating, processing, etc. In crushing, the ore may be crushed into smaller particles (e.g., from a first “large” particle size to a second “small” particle size). The step of crushing may be performed in stages by different types of crushers to effectively reduce the particle size to the second “small” particle size.

The step of screening may include dividing the crushed ore into multiple grades by particle size, or separating particles to different sizes. The step of screening facilitates in removing any organic and/or large-sized material from desired-sized material. In some aspects, the large-sized material may be crushed again by using the crushers. The step of mixing may include mixing the screened material (or output of the screening step) with water to form feed/slurry.

The step of separation may be performed in two steps, i.e., a first separation step and a second separation step. In the first separation step, the feed may be fed in a hydrocyclone to process and divide the feed to a first feed portion and a second feed portion based on particle size. The first feed portion may have a particle size in a range of 30-40 microns. In some aspects, the first feed portion may include or be rich in basalt, and the second feed portion may include or be rich in copper.

In the second separation step, the second feed portion may be fed in spiral machines to process and divide the second feed portion in concentrate and tailings. The concentrate may include or be rich in copper, and the tailings may include or be rich in basalt. The spiral machines may include a rougher, a cleaner, a recleaner, and a scavenger, which may be connected in stages/series in a predefined manner to effectively divide the second feed portion into concentrate and tailings.

The step of processing may include a first processing step and a second processing step. The first processing step may include processing/treatment of the concentrate to recover/purify the copper. The second processing step may include the step of treatment of the tailings to form the supplementary cementitious material or a cementitious additive. The first processing step may include the steps of dewatering and drying the concentrates, smelting, refining, and/or the like. In some aspects, the second processing step may include dewatering and drying the tailings, and further grinding the tailings to reduce the size of the tailings in a range of 10 to 40 microns (as an example) to form the supplementary cementitious material. In an exemplary aspect, the tailings may be grinded to reduce the size of the tailings to approximately 10 microns. In addition, the second processing step may include a step of calcining and addition of mineralizers to the tailings to form the supplementary cementitious material.

In additional aspects, the second processing step may further include processing the first feed portion to form the supplementary cementitious material from the first feed portion. For example, the first feed portion may be grinded to further reduce the size of first feed portion to approximately 10 microns. In addition, the second processing step may include a step of calcining and addition of mineralizers to the first feed portion.

The present disclosure discloses a system that facilitates in production of copper, and the supplementary cementitious material. In addition, the process is environment friendly and does not generate any waste that may be harmful. In addition, the process may save resources. The supplementary cementitious material may be used to produce concrete and may reduce cement usage by up to 15% to produce the concrete, which may be more environment friendly. These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

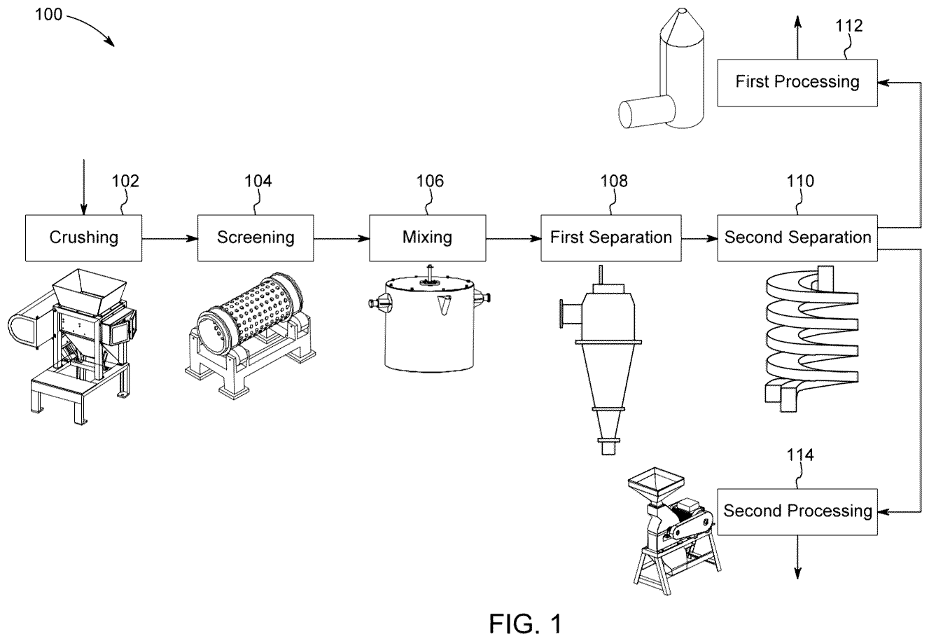

FIG. 1 depicts a schematic diagram of an example overall process 100 to extract minerals in accordance with the present disclosure. The process 100 is specifically directed towards formation/creation of a supplementary cementitious material (or cementitious additive), and formation/creation of a valuable resource copper in usable form.

The process 100 may include a step of crushing 102 the ore (e.g., basalt) obtained from mining, via one or more crushers. In this step, the crushers may crush the ore into smaller particles (e.g., from a first “larger” material size to a second “smaller” material size), which increases the surface area and exposes the minerals included in the ore for subsequent processing. As described above, the process of crushing 102 may be performed using one or more crushers. The crusher may be, for example, a vertical crusher (e.g., a vertical shaft impactor), a ball mill, a roll mill, a jaw crusher, and/or the like. In some aspects, the process of crushing 102 may be performed in stages, where each stage may use a different crushing machine to crush the ore. For example, the ore may be firstly crushed by using a jaw crusher, and then the crushed ore may be further crushed by using the vertical crusher to crush the ore to the second material size (i.e., smaller size).

The process 100 may further include a step of screening 104 the crushed ore, to process the crushed ore and divide the crushed ore into multiple grades by particle size. The step of screening 104 facilitates in removing any organics and large-sized material from the “desired-sized” material. In some aspects, the large materials may be passed through the step of crushing again to further reduce the size of the large materials. In some aspects, the step of screening 104 may be performed after the step of crushing 102. In alternative aspects, the step of screening 104 may be performed between crushing stages. For example, the crushed ore from a first crushing machine (e.g., a jaw crusher) may be processed by using a screening machine, and the screened ore may be further crushed by using a second crushing machine (e.g., a ball mill).

In some aspects, the step of screening 104 may be performed by using a trommel. A trommel is a mining equipment that includes a cylindrical drum that has many holes of a given/predefined size. The trommel may be configured to receive the crushed ore from the crusher(s) and rotate the cylindrical drum axially to process the crushed ore and divide the crushed ore based on the material size by using the holes. For example, the trommel may separate the large-sized material from the desired-sized material. In further aspects, the step of screening 104 may be performed by using a vibrating screen that may cause vibration motion of screen assembly to separate the large-sized material from the desired-sized material. The vibrating screen may be used in addition to or instead of the trommel.

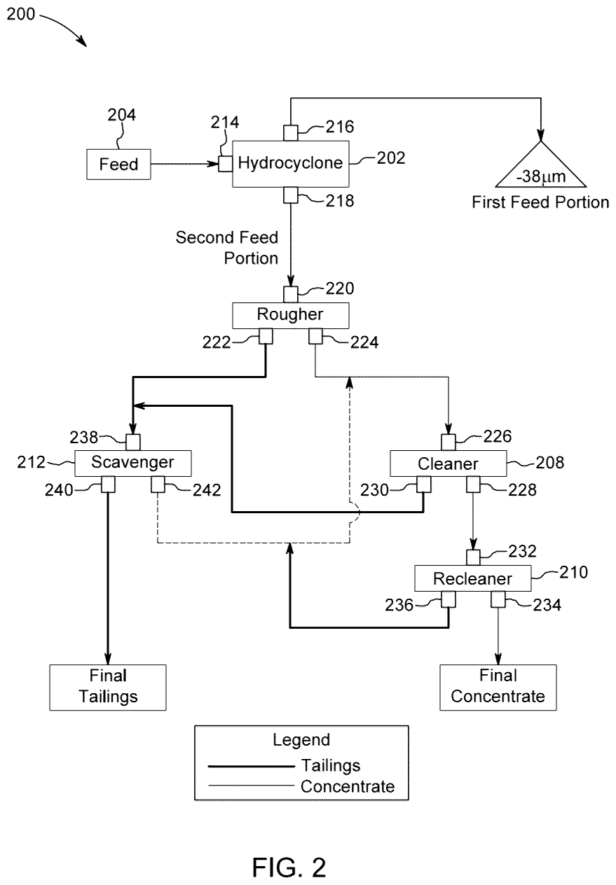

The process 100 may further include a step of mixing 106 in which the screened material (or output from the step of screening 104) may be mixed with water to form a feed/slurry (shown as feed 204 in FIG. 2). The mixing 106 may be performed by using a mixer.

The process 100 may further include a step of first separation 108 and a step of second separation 110 to separate minerals in the feed. In an exemplary aspect, the step of first separation 108 and the step of second separation 110 may cause separation of copper from basalt in the feed. The steps of first separation 108 and the second separation 110 may be performed in stages. For example, the output of the first separation 108 may be further treated in the second separation 110 to effectively separate the copper from basalt in the feed.

In some aspects, the step of first separation 108 may include a process to divide the feed into a first feed portion and a second feed portion. The first feed portion may include or be rich in basalt, and the second feed portion may include or be rich in copper. The step of second separation 110 may include a process to divide the second feed portion (generated from the first separation 108) into concentrate and tailings. The concentrate may include or be rich in copper, and the tailings may include or be rich in basalt.

The first separation 108 may be performed by using a hydrocyclone (shown as hydrocyclone 202 in FIG. 2), and the second separation 110 may be performed by using a plurality of spiral circuits. The plurality of spiral circuits may include, but is not limited to, a rougher, a cleaner, a recleaner, and a scavenger (shown as rougher 206, cleaner 208, recleaner 210, and scavenger 212 in FIG. 2). The hydrocyclone may be a cyclonic separator that separates product phases mainly on the basis of differences in specific gravity with aqueous solutions. Specifically, the hydrocyclone may separate solids or different phase fluids from the bulk fluid or feed. In some aspects, the hydrocyclone may receive the feed from the mixer and process the feed to divide the feed into the first feed portion and the second feed portion. As described above, the first feed portion may include or be rich in basalt, and the second feed portion may include or be rich in copper. Thus, in the first separation 108, the first feed portion may be separated from the second feed portion in the feed.

To perform the first separation 108 or to divide the feed into the first feed portion and the second feed portion, the feed may be fed into the hydrocyclone tangentially under a certain/predefined pressure. This may create a centrifugal movement (when the hydrocyclone may be rotating), pushing the heavier phase (e.g., the second feed portion) outward and downward alongside the wall of the conical part of the hydrocyclone. The heavier phase (e.g., the second feed portion) may then be discharged through a hydrocyclone downward outlet (shown as second hydrocyclone outlet 218 in FIG. 2).

The lighter phase (e.g., the first feed portion) may move upwards when the hydrocyclone may be rotating, and may get discharged through upward a hydrocyclone outlet (shown as first hydrocyclone outlet 216 in FIG. 2). In an exemplary aspect, a material size associated with the first feed portion may be in a range of 30-40 microns, which may be rich in basalt. In another exemplary aspect, the material size associated with the first feed portion may be approximately 38 microns. In yet another exemplary aspect, the material size associated with the first feed portion may be less than 30 microns. The second feed portion may include a mixture of copper and basalt, which may be fed to the spiral circuits to further separate copper and basalt in the second feed portion.

To perform the second separation 110 or to separate copper and basalt in the second feed portion, the spiral circuits/machines may receive the second feed portion from the hydrocyclone, and process the second feed portion to divide the second feed portion into concentrate and tailings. As described above, the concentrate may include or be rich in copper, and the tailings may include or be rich in basalt. The spiral machines may be configured to receive the material (or the second feed portion) from the top, move the material via the spirals to separate the heavy material from the light material due to specific gravity, and discharge the heavy material and the light material separately from the bottom. Due to the movement of the material in the spiral, the heavy material may move in proximity to an inner core of the spiral and the light material may separate out, which may facilitate in the separation of concentrate and tailings. The details of the spiral circuit are described below in conjunction with FIG. 2.

The process 100 may further include a step of first processing 112 and a step of second processing 114. The step of first processing 112 may include treatment of the concentrate from the spiral circuits (e.g., the recleaner 210) to recover/purify the copper. Stated another way, the step of first processing 112 may output copper. In some aspects, the recovery of copper from the ore may be in range of 1-2% of the ore quantity. The step of second processing 114 may include treatment of the tailings from the spiral circuits (e.g., the scavenger 212) to form a supplementary cementitious material or a cementitious additive. Stated another way, the step of second processing 114 may output the supplementary cementitious material or the cementitious additive. The supplementary cementitious material or the cementitious additive may be mixed with cement in a specific ratio to produce concrete. The use of supplementary cementitious material in producing concrete may reduce the cement usage by up to 15%, which may be more environment friendly.

In some aspects, the step of first processing 112 may include processing of the concentrate to further refine or purify the copper concentrate. In an exemplary aspect, the first processing 112 may include the steps of dewatering and drying the concentrates, smelting, refining, etc. In some aspects, the second processing 114 may include the steps of dewatering and drying the tailings, and further grinding the tailings to reduce the size of the tailings in the range of 10 microns to 40 microns (as an example). In an exemplary aspect, the tailings may be grinded to reduce the size of the tailings to approximately 10 microns. The grinding of the tailings to the above-mentioned size facilitates in the formation of the supplementary cementitious material that may be used to produce concrete. In addition, the step of second processing 114 of the basalt as a pozzolan may include a step of calcining and addition of mineralizers to the tailings to form the supplementary cementitious material. The step of calcining and addition of mineralizers improves the physical performance of basalt as the supplementary cementitious material.

In additional aspects, the second processing 114 may further include processing the first feed portion to form the supplementary cementitious material from the first feed portion. For example, the first feed portion may be grinded to further reduce the size of first feed portion to approximately 10 microns. In addition, the second processing step may include a step of calcining and addition of mineralizers to the first feed portion.

The first processing 112 may be performed by one or more first processing components, and the second processing 114 may be performed by one or more second processing components. The first processing components may be configured to process the concentrate from the spiral circuits to further refine the concentrate, and the second processing components may be configured to process the tailings from the spiral circuits to form the supplementary cementitious material. In some aspects, the second processing components may be configured to process the first feed portion (generated from the first separation 108) to form the supplementary cementitious material. In some aspects, the second processing components may include a grinder configured to grind the tailings from a first particle size to a second particle size. In some aspects, the second particle size may be in range of 10 microns to 40 microns. In other aspects, the second particle size may be approximately 10 microns.

FIG. 2 depicts an example system 200 to separate concentrate and tailings from a feed 204 in accordance with the present disclosure. The system 200 may include a plurality of units including, but not limited to, a hydrocyclone 202, a rougher 206, a cleaner 208, a recleaner 210, and a scavenger 212. As described above, the hydrocyclone 202 may be configured to process the feed 204 and divide the feed 204 into the first feed portion (that may be rich in basalt) and the second feed portion (that may be rich in copper). The spiral circuits/machines (e.g., the rougher 206, the cleaner 208, the recleaner 210, and the scavenger 212) may be configured to process the second feed portion from the hydrocyclone 202 to divide the second feed portion into concentrate (e.g., copper) and tailings (e.g., basalt).

The hydrocyclone 202 may include a hydrocyclone inlet 214, a first hydrocyclone outlet 216, and a second hydrocyclone outlet 218. The hydrocyclone inlet 214 may be configured to receive the feed 204 in the hydrocyclone 202. In an exemplary aspect, the first hydrocyclone outlet 216 may be configured to discharge the first feed portion from a hydrocyclone top portion (or any other hydrocyclone portion), and the second hydrocyclone outlet 218 may be configured to discharge the second feed portion from a hydrocyclone bottom portion (or any other hydrocyclone portion).

The plurality of spiral circuits described above in conjunction with FIG. 1 may include the rougher 206, the cleaner 208, and the recleaner 210. The rougher 206, the cleaner 208, and the recleaner 210 may include spirals that may be configured to pass the second feed portion to separate materials of the second feed portion due to gravity. In some aspects, the rougher 206, the cleaner 208, and the recleaner 210 may have same dimensions. Alternatively, the rougher 206, the cleaner 208, and the recleaner 210 may have different dimensions. The rougher 206, the cleaner 208, and the recleaner 210 may be connected in stages or series in a predefined manner to effectively divide the second feed portion into concentrate and tailings.

The rougher 206 may be configured to receive the second feed portion from the hydrocyclone 202, and make a “rough” separation of the second feed portion into rougher concentrate and rougher tailings. The rougher 206 may include a rougher inlet 220, a first rougher outlet 222, and a second rougher outlet 224. The rougher inlet 220 may be configured to receive the second feed portion from the hydrocyclone 202. The first rougher outlet 222 may be configured to output rougher tailings to the scavenger 212, and the second rougher outlet 224 may be configured to output the rougher concentrate to the cleaner 208.

The cleaner 208 may be configured to receive the rougher concentrate from the second rougher outlet 224, process the rougher concentrate to divide the rougher concentrate into cleaner concentrate and cleaner tailings. The cleaner concentrate may be a refined or cleaner version of the rougher concentrate. The cleaner 208 may include a cleaner inlet 226, a first cleaner outlet 228, and a second cleaner outlet 230. The cleaner inlet 226 may be configured to receive the rougher concentrate from the rougher 206 (specifically the second rougher outlet 224). The first cleaner outlet 228 may be configured to output the cleaner concentrate to the recleaner 210, and the second cleaner outlet 230 may be configured to output the cleaner tailings to the scavenger 212.

The recleaner 210 may be configured to receive the cleaner concentrate from the first cleaner outlet 228, process the cleaner concentrate to divide the cleaner concentrate into recleaner concentrate (or “final” concentrate) and recleaner tailings. The final concentrate may be a refined version of the cleaner concentrate. The recleaner 210 may include a recleaner inlet 232, a first recleaner outlet 234, and a second recleaner outlet 236. The recleaner inlet 232 may be configured to receive the cleaner concentrate from the cleaner 208. The first recleaner outlet 234 may be configured to output the final concentrate that may be rich in copper, which may be further processed by using the first processing 112 described in conjunction with FIG. 1. In some aspects, the second recleaner outlet 236 may be configured to output recleaner tailings to the scavenger 212. In other aspects, the second recleaner outlet 236 may be configured to output recleaner tailings to the cleaner 208 (e.g., to the cleaner inlet 226).

The scavenger 212 may be configured to receive the tailings from the rougher 206, the cleaner 208, and recleaner 210, and treat the tailings as they may still contain valuables. The scavenger 212 may include a scavenger inlet 238, a first scavenger outlet 240, and a second scavenger outlet 242. The scavenger inlet 238 may be configured to receive the rougher tailings, the cleaner tailings, and the recleaner tailings from the rougher 206, the cleaner 208, and the recleaner 210 respectively. The first scavenger outlet 240 may be configured to output the tailings (e.g., “final” tailings) that may be rich in basalt. The second scavenger outlet 242 may be configured to output scavenger concentrate to the cleaner 208 (e.g., to the cleaner inlet 226).

The tailings (or the “final” tailings) may be further processed by using the second processing 114 described in conjunction with FIG. 1 to the supplementary cementitious material that may be used to produce concrete. The supplementary cementitious material may be mixed with cement in a specific ratio to form the concrete. The use of the supplementary cementitious material in producing concrete may reduce cement usage by up to 15%, which may be more environment friendly.

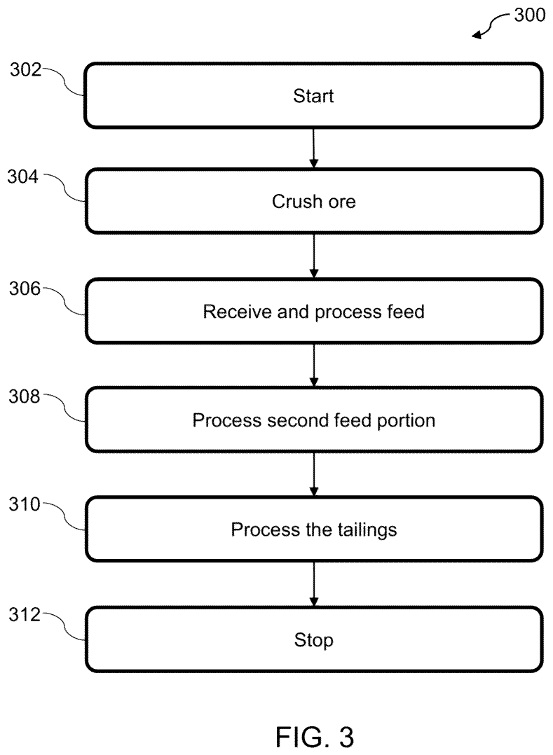

FIG. 3 depicts an example flow diagram of a method 300 to extract minerals in accordance with the present disclosure. The FIG. 3 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 300 may start at step 302. At step 304, the method 300 may include crushing ore. At step 306, the method 300 may include receiving and processing the feed 204 to divide the feed 204 into the first feed portion and the second feed portion. The feed 204 may include a mixture of crushed ore and water. At step 308, the method 300 may include processing the second feed portion to divide the second feed portion into concentrate and tailings. The concentrate may include copper and the tailings may include basalt. At step 310, the method 300 may include processing the tailings to form a supplementary cementitious material. The method 300 may end at step 312.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc., should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A system comprising:
one or more crushers configured to crush ore;
a hydrocyclone configured to receive and process a feed to divide the feed into a first feed portion and a second feed portion, wherein the feed is a mixture of crushed ore and water;
a plurality of spiral circuits configured to process the second feed portion to divide the second feed portion into a concentrate and tailings, wherein the concentrate comprises copper and the tailings comprises basalt; and
one or more first processing components configured to process the tailings to form a supplementary cementitious material.

2. The system of claim 1, wherein the one or more first processing components is further configured to process the first feed portion to form the supplementary cementitious material.

3. The system of claim 1, wherein the one or more first processing components comprises a grinder configured to grind the tailings from a first particle size to a second particle size to form the supplementary cementitious material.

4. The system of claim 3, wherein the second particle size is in a range of 10 microns to 40 microns.

5. The system of claim 3, wherein the second particle size is 10 microns.

6. The system of claim 1, wherein the one or more first processing components is further configured to perform calcining and add mineralizers to the tailings.

7. The system of claim 1, wherein the first feed portion has a third material size in a range of 30-40 microns, and wherein the first feed portion is basalt.

8. The system of claim 1, wherein the plurality of spiral circuits comprises a rougher, a cleaner, a recleaner, and a scavenger.

9. The system of claim 8, wherein the rougher comprises a rougher inlet, a first rougher outlet, and a second rougher outlet, wherein the rougher inlet is configured to receive the second feed portion from the hydrocyclone, wherein the first rougher outlet is configured to output rougher tailings to the scavenger, and wherein the second rougher outlet is configured to output a rougher concentrate to the cleaner.

10. The system of claim 9, wherein the cleaner comprises a cleaner inlet, a first cleaner outlet, and a second cleaner outlet, wherein the cleaner inlet is configured to receive the rougher concentrate from the rougher, wherein the first cleaner outlet is configured to output a cleaner concentrate to the recleaner, and wherein the second cleaner outlet is configured to output cleaner tailings to the scavenger.

11. The system of claim 10, wherein the recleaner comprises a recleaner inlet, a first recleaner outlet, and a second recleaner outlet, wherein the recleaner inlet is configured to receive the cleaner concentrate from the cleaner, wherein the first recleaner outlet is configured to output the concentrate.

12. The system of claim 11, wherein the second recleaner outlet is configured to output recleaner tailings to the scavenger.

13. The system of claim 12, wherein the scavenger comprises a scavenger inlet, a first scavenger outlet, and a second scavenger outlet, wherein the scavenger inlet is configured to receive the rougher tailings and the cleaner tailings from the rougher and the cleaner respectively, and wherein the first scavenger outlet is configured to output the tailings.

14. The system of claim 13, wherein the second scavenger outlet is configured to output scavenger concentrate to the cleaner.

15. The system of claim 1, wherein the one or more crushers comprises a vertical crusher.

16. The system of claim 1, wherein the one or more crushers comprises a ball mill or a roll mill.

17. The system of claim 1 further comprising one or more second processing components configured to process the concentrate to purify the concentrate.

18. A method comprising:
crushing ore;
receiving and processing a feed to divide the feed into a first feed portion and a second feed portion, wherein the feed is a mixture of crushed ore and water;
processing the second feed portion to divide the second feed portion into a concentrate and tailings, wherein the concentrate comprises copper and the tailings comprises basalt; and
processing the tailings to form a supplementary cementitious material.

19. The method of claim 18, wherein processing the tailings comprises grinding the tailings from a first particle size to a second particle size to form the supplementary cementitious material, and performing calcining and adding mineralizers to the tailings.

20. A system comprising:
one or more crushers configured to crush ore;
a hydrocyclone configured to receive and process a feed to divide the feed into a first feed portion and a second feed portion, wherein the feed is a mixture of crushed ore and water;
a plurality of spiral circuits configured to process the second feed portion to divide the second feed portion into a concentrate and tailings, wherein the concentrate comprises copper and the tailings comprises basalt; and
one or more processing components configured to process the tailings to form a supplementary cementitious material, wherein the one or more processing components comprises a grinder configured to grind the tailings from a first particle size to a second particle size.
